(19) United States
(12) Patent Application Publication
(10) Pub. No.: US 2025/0202425 A1
(43) Pub. Date: Jun. 19, 2025

(54) SOLAR MODULE RECYLING THROUGH ARTIFICIAL INTELLIGENCE

(71) Applicant: SOLARCYCLE, Inc., Mesa, AZ (US)

(72) Inventors: Paul MCDONALD, Mesa, AZ (US); Guilherme GARCIA SCHU PEIXOTO, Mesa, AZ (US); Pablo RIBEIRO DIAS, Mesa, AZ (US); Suvi SHARMA, Mesa, AZ (US)

(21) Appl. No.: 18/988,268

(22) Filed: Dec. 19, 2024

Related U.S. Application Data
(60) Provisional application No. 63/612,073, filed on Dec. 19, 2023.

(51) Int. Cl. H02S 50/00; B07C 5/34

(52) U.S. Cl. CPC H02S 50/00; B07C 5/34

(57) ABSTRACT

Embodiments employ Artificial Intelligence (AI) techniques to collect and analyze data associated with material input to a solar module recycling system, including e.g., AI model(s) and/or the recycling and recapture of the component materials. Recycling hardware for various functional areas (e.g., junction box/frame/glass removal; chemical/mechanical/physical separation; testing; sorting; cleaning; others) may be integrated to a central engine for processing and/or storage (e.g., in a database). Analysis of module recycling using the AI techniques may consider one or more of the following: module model; module manufacturer; module type (e.g., c-Si versus CdTe); power rating; module history; module label information; predicted/actual market prices; others. An outcome of AI analysis can offer estimates of resultant effect(s) upon speed and efficiency, by which materials travel through the recycling system. One possible benefit is the ability to rapidly optimize system parameters, providing high solar module throughput in the recycling system over time.

### CROSS-REFERENCE TO RELATED APPLICATION

The instant nonprovisional patent application claims priority to U.S. Provisional Patent Application No. 63/612,073 filed Dec. 19, 2023 and which is incorporated by reference herein for all purposes.

### BACKGROUND

As world population increases, the earth is subjected to escalating environmental stress. One form of stress is manifest in rising global temperatures attributable to the burning of fossil fuels in order to provide energy needs.

Alternative energy sources can provide power, while lessening the carbon dioxide burden on the planet. One important source of alternative energy is solar power.

Photovoltaic (PV) modules are complex manufactured items. They harness the sun's energy and convert it into a usable energy source for residential, commercial and utility-scale applications. As the climate has been significantly impacted by the use of fossil fuels over the past century, the need for alternative sources of energy like solar has taken on greater importance.

Another form of environmental stress imposed upon the earth, is the accumulation and disposal of waste products from human activity. Accordingly, rather than discarding a solar module at the end of its lifetime, it may be desirable to recycle material(s) from a solar module for reuse and thereby avoid deposition in a landfill.

### SUMMARY

Embodiments employ Artificial Intelligence (AI) techniques to collect and analyze data associated with material input to a solar module recycling system, including e.g., AI model(s) and/or the recycling and recapture of component materials. Recycling hardware for various functional areas (e.g., junction box/frame/glass removal; chemical/mechanical/physical separation; testing; sorting; cleaning; others) may be integrated to a central engine for processing and/or storage (e.g., in a database). Analysis of module recycling using AI techniques may consider one or more of the following: PV module model/manufacturer/type (e.g., c-Si versus CdTe); module power rating; module history; module label information; predicted/actual market prices of materials; others. An outcome of AI analysis can offer estimates of resultant effect(s) upon speed and efficiency, by which materials travel through the recycling system. One possible benefit is the ability to rapidly optimize system parameters, providing high solar module throughput in the recycling system over time.

### BRIEF DESCRIPTION OF THE DRAWINGS

FIG. 1 shows a cross-sectional view of a monofacial solar module according to an example.

FIG. 1A shows a simplified overhead view of the laminate of a solar module, lacking the frame and the top transparent sheet.

FIG. 2 is a simplified cross-sectional view showing a wire to cut through one or more layers.

FIG. 3 shows glass under polarized light. Parts of the material under stress display different colors. Here, stress gradients point to the top where the stress is highest.

FIG. 4 shows a shows a piece of glass under stress.

FIG. 5 shows a conveyor belt approach with the panel moving towards a rotary cleaning device.

FIG. 6 shows a conveyor belt approach with the rotary cleaning device moving toward a panel.

FIG. 7 shows a conveyor belt with an opening to clean both sides of the panel.

FIG. 8 shows a conveyor belt approach flipping panels to allow cleaning of both sides of a panel.

FIG. 9 shows a gripping device approach with the panel moving to a rotary cleaning device.

FIG. 10 shows a gripping device approach with the rotary cleaning device moving towards the panel.

FIG. 11 shows a scraper with a triangular edge to remove particles.

FIG. 12 shows a simplified flow of a cleaning procedure.

FIG. 13 shows a flow diagram of a condensed testing protocol.

FIGS. 14A-B show a more detailed testing protocol.

FIG. 15 shows a simplified block diagram of handling of a used solar module according to an embodiment.

FIG. 16 shows exemplary, non-exclusive database tables.

FIG. 17 is a simplified flow diagram showing application of AI to evaluating condition of used solar modules.

### DESCRIPTION

Solar modules exist in a variety of types and architectures. Examples of such modules can include but are not limited to:
Monocrystalline Solar Panels (Mono-SI)
Polycrystalline Solar Panels (p-Si)
Amorphous Silicon Solar Panels (A-SI)
Cadmium telluride photovoltaics (CdTe)
Copper indium gallium selenide modules (CIGS)
Copper indium selenide modules (CIS)
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels
Polymer-Based Solar Panels
Solar Roof Tiles
Solar Roof Shingles

Solar modules can last decades, with some degradation in performance over a module's lifetime. Also, solar modules that have been deployed on residential rooftops and other commercial and utility-scale applications for a number of years, may be decommissioned for a variety of reasons.

For example, (residential, commercial, utility) users of solar panels may desire to exchange their modules for newer, higher performing modules in order to maximize the amount of energy obtained from a solar array.

As more solar modules reach the end of their useful lives and/or are relinquished by their owners, it is desirable to dispose of the panels in an environmentally-friendly and economically-feasible way. Alternatively, it may be desired to refurbish and reuse existing solar modules to prolong their lifetimes and reduce cost.

Once it is determined that a solar module is no longer useful to its owner, e.g.:
the module has reached the end of its current deployment due to non- or underperformance,
the module has been damaged in transit, or
for other (e.g., economic) reasons,
   in order to avoid discarding the module into a landfill, the module may either be recycled or refurbished and reused.

Accordingly, to determine whether a solar module should be recycled or refurbished and reused, embodiments may implement one or more of the following processes, alone or in various combinations and sequences.
cleaning;
inspection to determine reusability;
testing;
remove cabling;
remove frames surrounding the panel and/or junction boxes (either manually, or e.g., using an automated deframing machine).
transparent front layers and potentially other layers (e.g., the backsheet) may be removed using a delamination process.

Remaining layers (of, e.g., a laminate) may be shredded. Shredded materials can be separated using one or more processes in order to extract various possible reusable materials therefrom (e.g., valuable commodity metals such as silicon, silver, and/or copper).

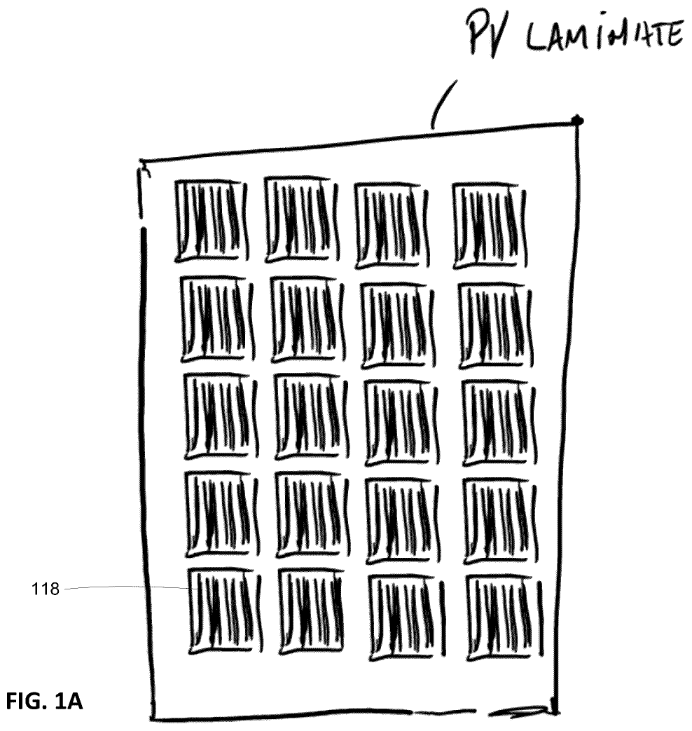

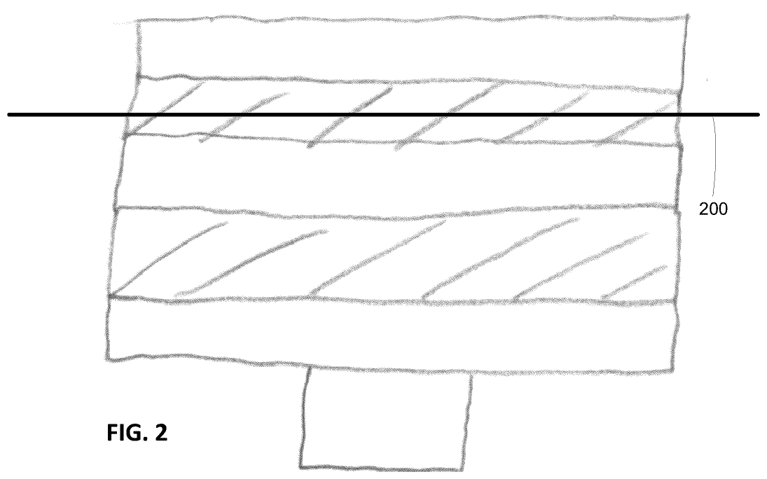

Embodiments relate to various techniques that may be employed, alone or in combination, for the recycling and/or refurbishment of solar modules. FIG. 1 shows a cross-sectional view of a monofacial solar module according to an example.

The PV module 100 is made of different layers assembled into the structure shown in FIG. 1. These layers of FIG. 1 are not drawn to scale.

The layers of FIG. 1 can be simplified as:
substrate (backsheet) 102,
back encapsulant 104, e.g., Ethylene-vinyl acetate (EVA), silicone, Polyvinyl butyral (PVB), IONOMER, polyolefin elastomer (POE)
solar cell 106 comprising PV material (including, e.g., but not limited to: doped single crystal, polycrystalline, or amorphous silicon, Group III-V materials) and metallization,
front encapsulant 108,
transparent front cover sheet 110 (e.g., typically glass).
   This grouping of layers is referred to as a laminate 112.

It is further noted that bifacial modules also exist. Such bifacial modules may exhibit a structure similar to that of FIG. 1, but have a transparent (e.g., glass) layer instead of a backsheet layer. This allows (e.g., reflected) light to enter the module from the back.

The laminate in FIG. 1 is surrounded by a frame 114. The frame may comprise a stiff metal such as aluminum. Alternatively, a frame material may be plastic, comprising e.g., polycarbonate.

A junction box 116 is also part of the module. The junction box may be potted (more common in newer models) or non-potted (more common in older models). In a the potted PV junction box, the foils coming out of the solar panel are soldered to the diodes in the junction box, and the junction box is potted or filled with a type of sticky material to allow thermal transfer of heat to keep the solder joint in place and prevent it from falling. Fabrication may take longer but creates a better seal.

In the non-potted PV junction box, a clamping mechanism is used to attach the foil to the wires in the junction box. This can involve a faster assembly, but may not be as robust. A module having a potted junction box may be more amenable to recycling or refurbishment.

FIG. 1A shows a simplified overhead view of the laminate of a solar module, lacking the frame and the top transparent sheet. FIG. 1A shows solar cells including patterned metallization 118, which may comprise, e.g., a valuable metal such as silver.

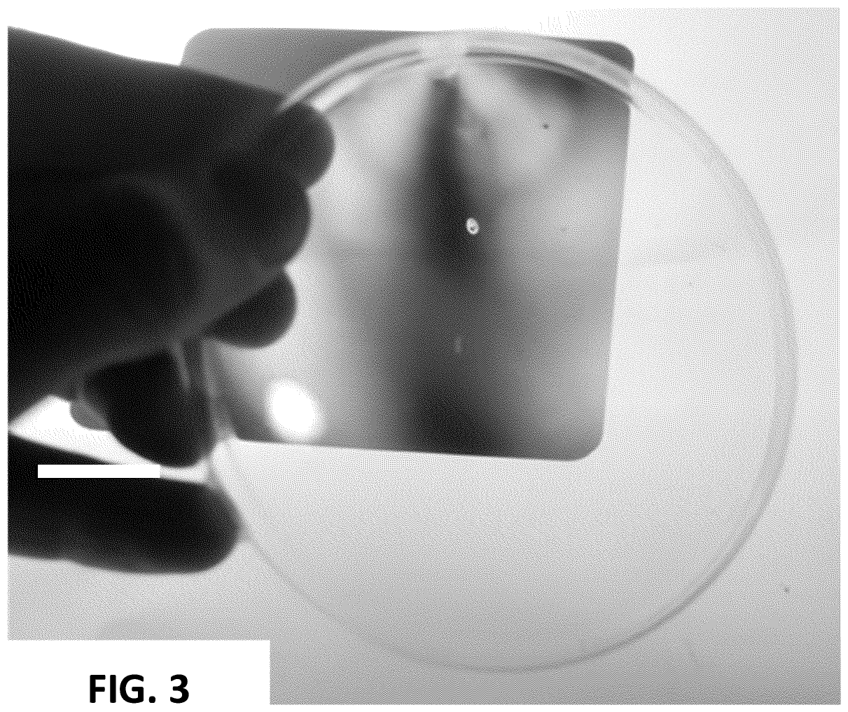

Prior to delamination, the frame is removed. Then, as shown in FIG. 2, according to embodiments a thin wire 200 may be used to cut through one or more layers (e.g., front encapsulant, back encapsulant, both front and back encapsulant, backsheet) of the PV laminate.

In some embodiments, the wire may be heated to temperatures of between about 400-600° C. For particular embodiments, this can be achieved by applying a difference of electric potential between the two ends of the wire.

The heated wire can then be pushed through encapsulant layer(s). This effectively separates the laminate into different parts.

According to some embodiments, the heat of the wire effectively degrades (“melts+burns”) the encapsulant. In certain embodiments, the wire physically cuts through the encapsulant material. The encapsulant material may be merely softened to allow passage of the wire.

In particular embodiments, the wire may have a diameter of 0.5 mm or less. Specific embodiments may employ a wire having a diameter of between about 0.2-0.5 mm.

A wire material useful for embodiments, may exhibit high mechanical strength and sufficiently low electrical conductivity to generate the heat by resistive heating. Examples of possible candidates for wire materials include but are not limited to:
NiCr alloy,
stainless steel,
FeCrAl alloy,
aluminum (such as 6000 series),
copper coated materials.

Delamination according to particular embodiments, may separate the top (e.g., glass) sheet and the rest of the layers. For some embodiments, the delamination process could separate the laminate into three (3) distinct layers: the top sheet (e.g., glass), the solar cell, and the backsheet. For some embodiments, the delamination process could separate the laminate from the backsheet.

Embodiments may determine where pressure is specifically to be applied as part of a delamination process. For example, embodiments may determine a location as to where the wire should engage with the module.

One possible approach to targeting a location of application of the hot wire may be based upon optics. That is, differences in refraction index of cover sheet (e.g., glass) versus encapsulant (e.g., EVA) may be detected.

Another possible approach to wire targeting may be based upon X-Ray Diffraction (DRX). One example could detect an amorphous structure of a glass cover sheet, versus a semi-crystalline structure of EVA.

One possible approach to wire targeting, is to have the wire push against the glass as to create an angle between 5-45° from the panel inclination. Exerting a force down on the wire can serve to keep the panel flat during processing.

For some embodiments, data relating to factors including but not limited to:
panel size,
panel model, and/or
panel weight.
   Could be stored in a database that is in turn referenced to output a thickness of the glass. The laminate could be aligned relating the model, manufacturer, and/or year to a database.

Use of a hot wire for delamination according to embodiments may offer one or more benefits. A first benefit is low energy use to heat up the wire. Another possible benefit is precise application of the wire to the laminate, resulting in clean separation of the layers.

Embodiments may employ testing of PV modules, in order to determine whether they can be reused or recycled. In addition to panel size, information such as width, length, height, thickness of glass, could assist in guiding the process. Such information could be obtained as part of a history file received with the panel. Alternatively, such information could be available from the manufacturer, solar panel owner, research institutes and/or public sources.

In particular, the transparent front cover sheet used in PV modules may be tempered glass. Such material is under compressive stress on the outside, and under tensile stress on the inside. When the tempered glass breaks, it releases the energy stored in the form of compressive and tensile stress.

Polarized light interacts differently with materials experiencing different stress levels. Regions of the material experiencing different stress, may appear as different colors.

Under some circumstances, panels having a broken cover sheet may not be eligible for reuse, and instead may be earmarked for recycling. Using polarized light, embodiments may facilitate rapid and accurate assessment of solar panel reuse.

That is, fractures release material tension, and thus change the visual pattern observed under polarized light. Thus under polarized light, glass may be seen to have a fracture revealed by a stress pattern different over that expected of intact tempered glass. Such an image may be acquired, stored, and accessed for manual or automatic review. This technique could detect fractures that are not detectable by human eye but that are nonetheless a determinant in deciding whether a module is earmarked for module recycling versus reuse.

Identification of damaged versus undamaged glass can be achieved using various type of devices. For example, particular embodiments can use polarimeter equipment, and/or polarizers and visual inspection.

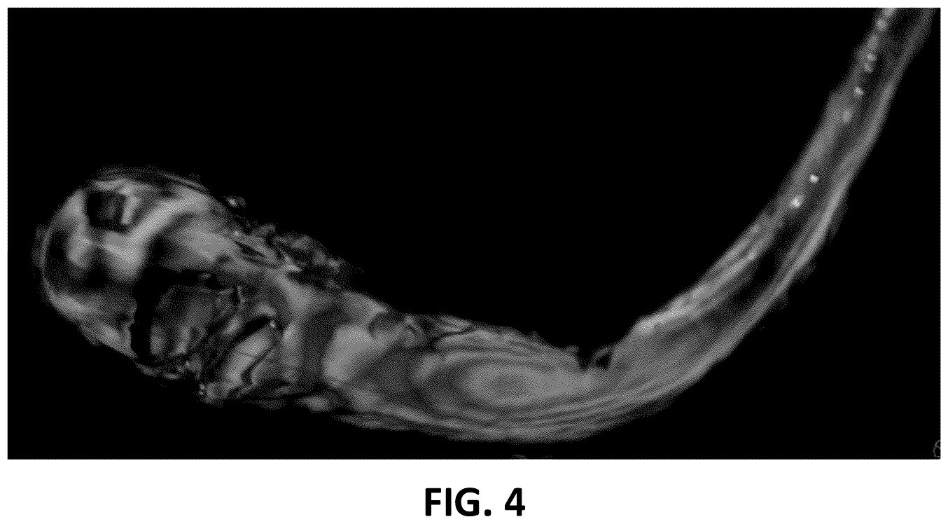

FIG. 3 shows glass under polarized light. Parts of the material under stress display different colors. Here, stress gradients point to the top where the stress is highest.

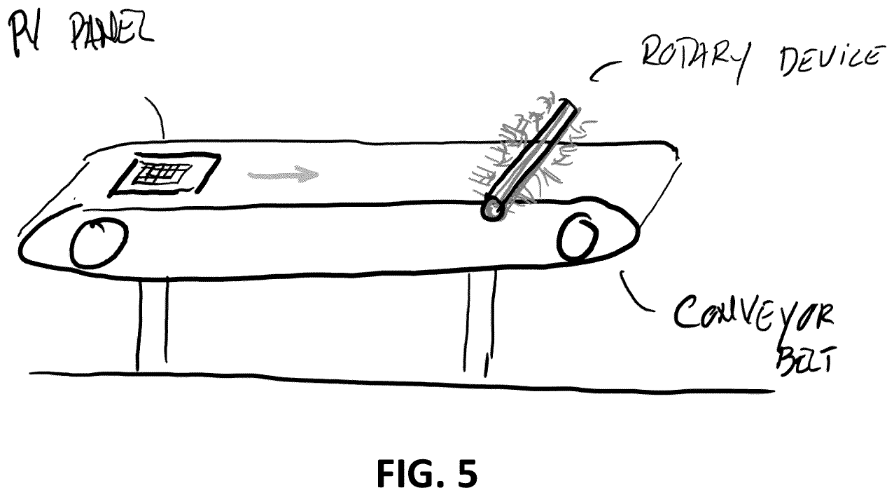

FIG. 4 shows a shows a piece of glass under high compression stress on the outside, and high tension stress on the inside. Polarized light highlights the stresses being experienced by the glass.

Testing of PV modules according to embodiments, may offer one or more benefits. One benefit is increased accuracy over visual inspection with the naked eye. Another benefit is reduced cost, as the polarimeter equipment and/or polarizers that are employed may be less expensive than specialized photovoltaic testing equipment.

It is noted that dirt and other debris may accumulate during the operation of photovoltaic (PV) panels owing to their deployment in the field. Such dirt covering can impair performance of a PV module.

During their lifetimes, solar panels may be periodically cleaned to ensure that maximum sunlight arrives at the PV solar cell. However, such periodic cleaning during operation lifetimes generally only takes place on a top surface (e.g., exposed glass). Moreover, once they are decommissioned, solar panels may be stockpiled unprotected from the environment, where additional dirt can accumulate.

Dirt (i.e., dust or particles accumulating in the posterior, anterior or side surfaces of a PV panel) can hinder the management of modules following their decommissioning. In the case of solar panel reuse, they can hinder testing to sort the modules (e.g., with respect to power output). In the case of solar panel recycling, dirt can mix with the particles of specific materials intended for recovered during the recycling process, lowering purity of the output material.

Accordingly, embodiments may implement cleaning approaches for solar panels. Such cleaning may occur at one or more stage(s) of end-of-life processing of a PV panel, e.g.:
at initial intake/inspection;
before and/or after deframing;
before and/or after testing;
before and/or after delamination;
before and/or after material separation.

According to one approach, panels (including the frame or no longer including the frame) are laid flat horizontally on conveyor belts, and passed through a rotary device (comprising, e.g., sponges, mops, and/or cloths). These may comprise e.g., woven yarn and/or microfiber. Microfiber candidates include but are not limited to polyesters, polyamides, and/or polyester.

The rotary device can be dry, damp, or wet. In some embodiments, the panels can be maintained stationary as rotary sponges/mops/cloths move along the axis of the module.

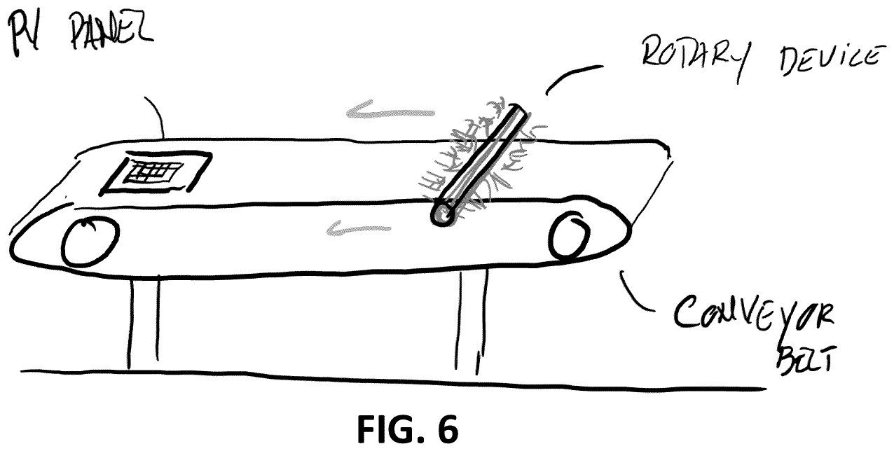

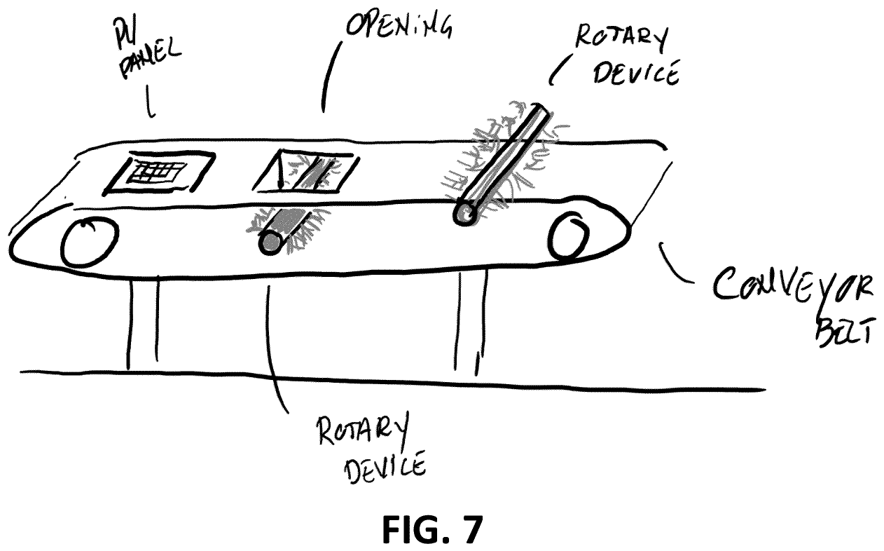

According to various embodiments, the rotary sponges/mops/cloths may rotate about their own axes, with the panels moving on a conveyor belt. FIG. 5 shows an approach wherein a panel moves towards a rotary cleaning device. FIG. 6 shows an approach wherein a rotary cleaning device moves towards a panel.

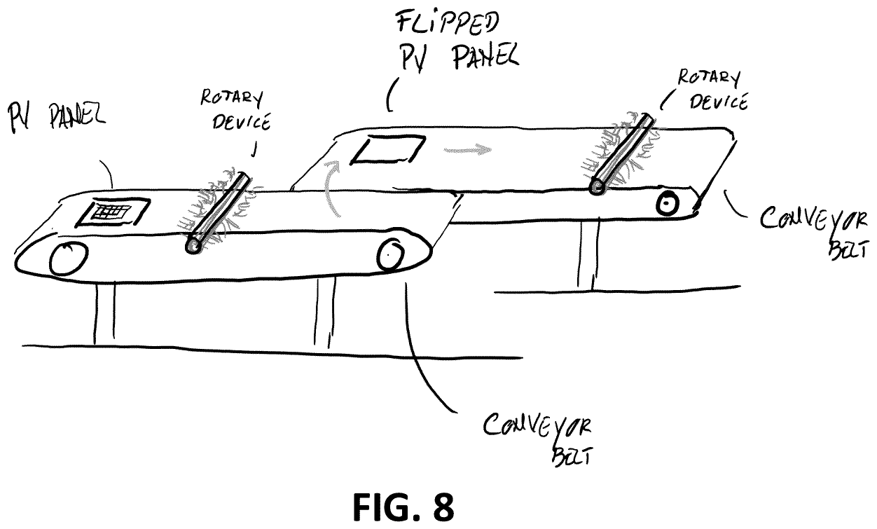

Particular embodiments may feature a conveyor belt including an opening to allow cleaning of both sides of the panel. FIG. 7 shows one embodiment of such an approach.

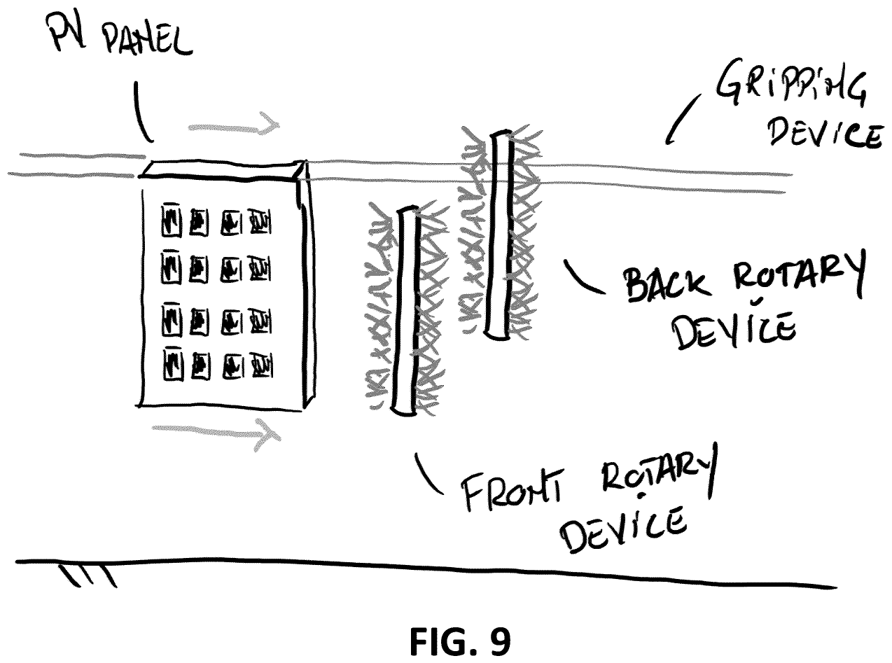

Various embodiments could flip the panels to allow cleaning of both sides of a panel. FIG. 8 shows one embodiment of such an approach.

Embodiments may or may not employ a second rotary device to clean the panels once they are flipped. Particular embodiments could have the rotary device move back and forth along the axis of the panel to ensure it cleans both sides of the panel.

Some embodiments could have the conveyor belt reverse the direction of movement after panels have been flipped. This can ensure that both sides are cleaned.

According to specific embodiments, PV panels could be vertically suspended (e.g., by their frames or by the layered structure lacking any frame). Two rotary sponges, mops, or cloths could be applied opposing sides of the panel. In some embodiments, the panels can remain in position while the rotary devices move perpendicular to the axis of the module.

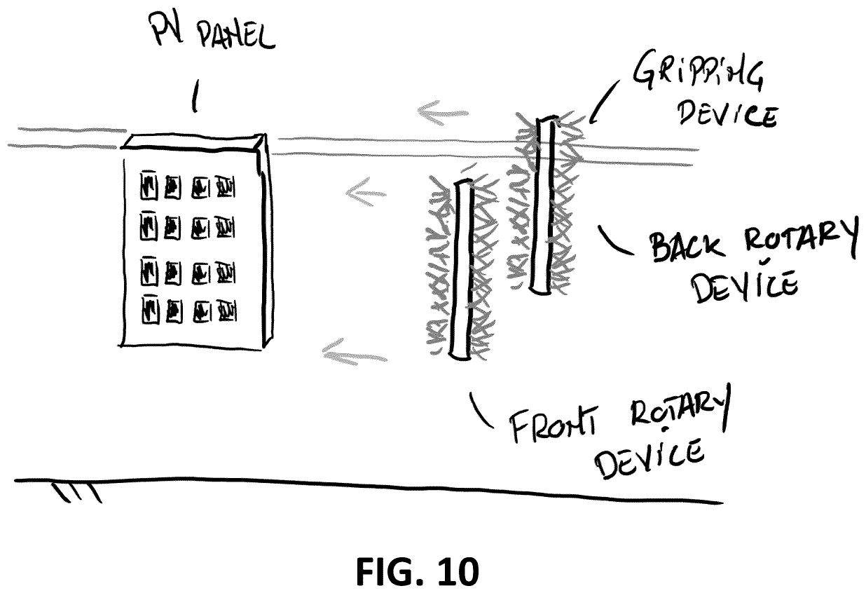

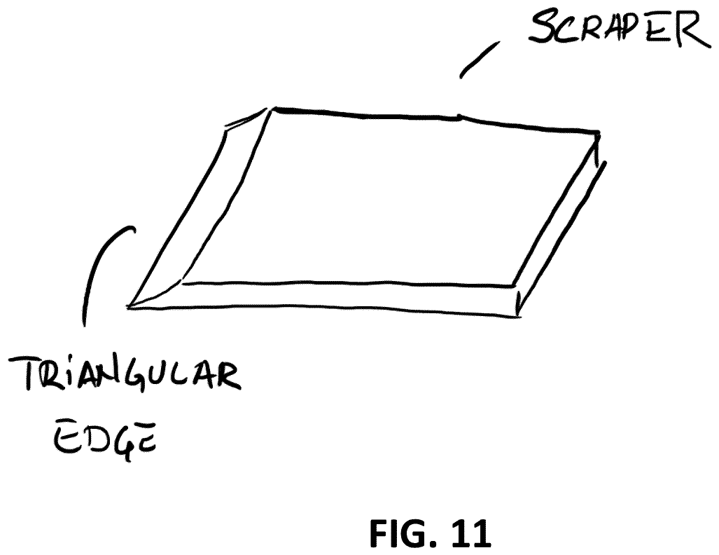

Alternatively, the rotary devices may remain are fixed and only rotate about their own axis, and the panels are the ones who move through the conveyor belt. FIG. 9 shows an embodiment in which the panel moves towards rotary cleaning device. FIG. 10 shows an approach in which the rotary cleaning device moves towards the panel.

It is noted that embodiments may or may not employ more than one rotary device to assist in cleaning of the panels. Certain embodiments may or may not reverse the direction of movement of the panels to ensure optimal cleaning of the panels. Various embodiments may or may not reverse the direction of movement of the rotary device(s) to ensure optimal cleaning of the panels.

While the above description has focused upon the use of rotary devices for cleaning, this is not required. Some embodiments may employ a pressure jet of water and/or an air jet to clear dirt and/or dry the panels.

Particular embodiments may suspend the panels vertically, and apply water and/or air jets to one or both sides, simultaneously or in sequence. Simultaneous application of jet(s) can desirably serve to counter balance forces applied to the module.

Particular embodiments may have multiple (e.g. between 2-4) jet angles at which the stream encounters the panel surface. Such multiple angles can aid in cleaning, and can act simultaneously or in sequence.

Embodiments for cleaning PV modules can be performed automatically or manually. In the latter case, one or more operators can handle the various devices such as sources of water and/or air jets.

Different ranges of pressure can be used. Jet pressures can be high, medium, or low. Examples of lower jet pressures can include from about 50-200 MPa.

According to some embodiments, panels can also be laid flat horizontally, with the jet applied horizontally as to aid in particle removal. Example angles can be from between about 1-20° from horizontal.

Horizontal or near-horizontal approaches may not use a conveyor belt with an opening so that both sides of the panel could be cleaned by jet(s). Horizontal or near-horizontal approaches may or may not flip upside down the panels, so that both sides can be cleaned by jet(s).

Horizontal or near-horizontal approaches may or may not employ a second water/air jet device to clean the panels. Embodiments may have the water and/or air jet device move back and forth along the axis of the panel, to clean one or both sides of the panel. Embodiments may have a conveyor belt reverse the direction of movement, in order to ensure both sides are cleaned.

While the above has described the application rotary devices and/or jets for cleaning, this is not required. Certain embodiments may use scraper devices, thereby avoiding water.

According to one such embodiment, panels may lay flat and be moved horizontally on a surface or conveyor belt. A scraper made with a triangular tip is used to remove particles from the surface of the module.

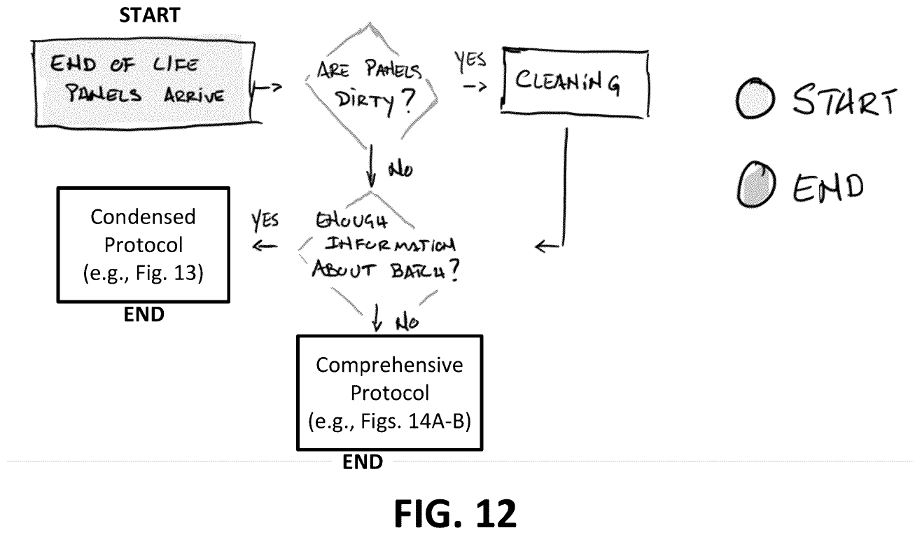

A tip of the scraper has triangular shape with an angle between about 1-55° with the horizontal. FIG. 11 shows a scraper with a triangular edge to remove particles laying in the surface of the panels.

Various embodiments may have scraper(s) fixed in one position of the conveyor belt and the panels pass through. Some embodiments could have the panels be still, with scraper(s) moving along the surface of the panel.

Various embodiments may include follow up process(es). One example of a follow up process is the use of air suction such as a vacuum cleaner.

Again, embodiments employing a scraper may feature a conveyor belt with an opening so that both sides of the panel could be cleaned. Some embodiments may or may not flip upside down the panels to allow both sides to be cleaned.

Embodiments utilizing a scraper may or may not employ an additional scraper to clean the panels once they are flipped. Scraper(s) may move back and forth along the axis of the panel to ensure that both sides of a panel are cleaned. Embodiments may have the conveyor belt reverse the direction of movement to enhance cleaning.

According to some embodiments, a scraper may be plastic. Examples of materials forming a scraper can include but are not limited to:
Polyethylene Terephthalate (PET),
Low-Density Polyethylene (LDPE),
High-Density Polyethylene (HDPE),
Polypropylene (PP),
Polyisoprene, and/or
Polymethyl Methacrylate (PMMA).

Embodiments that utilize scraper(s) may be performed automatically or manually. For the latter, one or more operators could handle the scraper(s).

Details regarding overall flows of recycling and/or refurbishment of solar modules according to various embodiments, is now described.

Specifically, PV modules may be designed and manufactured to last as long as 25-30 years in operation. However, panels may be decommissioned prior to reaching such a threshold.

Some decommissioned modules may still be in working condition and may be replaced in the field (reused), while others are not. Deciding whether a module can be reused or if it should be recycled, is one aspect of the management of PV modules.

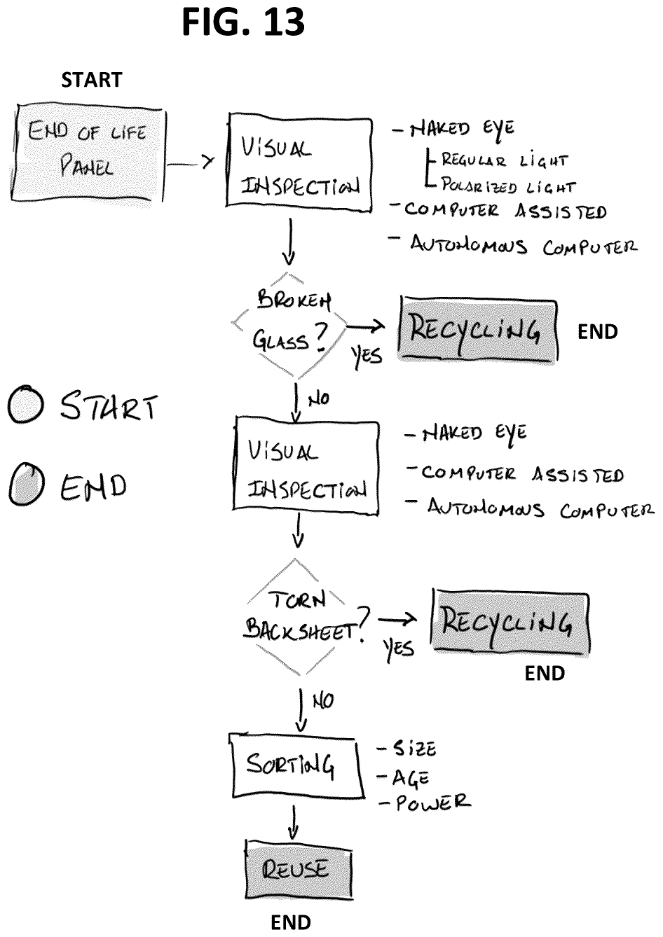

According to one embodiment, a series of steps shown in FIG. 12 can optimize, simplify, and lower the cost of testing used PV panels to determine their suitability for refurbishment or reuse.

As shown in FIG. 12, if a batch of panels arrives dirty (i.e., with visible dirt in the front or back of the panel), a cleaning procedure may take place. The cleaning procedure:
may or may not involve the use of water and/or soap,
may or may not use water jets,
may or may not use air jets,
may or may not use cloths (wet or dry), and/or
may or may not use dry scrapers.
   The cleaning process may be performed manually or in an automated fashion.

Sometimes information regarding the state of the incoming used PV panels may be available. Such information can include, but is not limited to one or more of:
maintenance history;
prior deployment conditions indicative of wear (e.g., harsh site conditions);
panels known to be non-operational;
power performance (i.e., how much energy is able to be output at the instant time by a module/string of modules);
images of panels, including but not limited to visual (e.g., showing cracking), polarized (e.g., showing stress), photoluminescence, electroluminescence, and/or infra-red;
inverter or power electronics data.

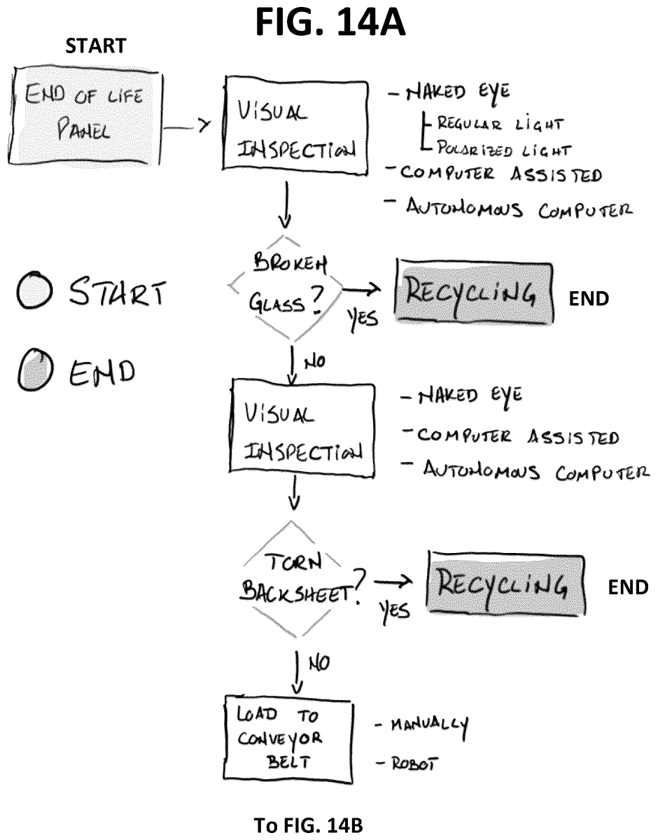

When some information is available, a more thorough testing protocol may be bypassed. This lowers cost and speeds up the process. In such cases, a condensed testing protocol such as is shown in FIG. 13, may be implemented.

A condensed testing protocol according to an embodiment may involve visual inspection to look for damage on the front sheet (e.g. glass) and/or on the backsheet. Such inspection can be done manually and/or automatically. Such inspection can be done with or without the use of polarized light.

Damaged modules are sent for recycling. Undamaged modules may be sorted according to one or more factors including but not limited to:
power output,
size
age
history
label/identification
current output
voltage output.

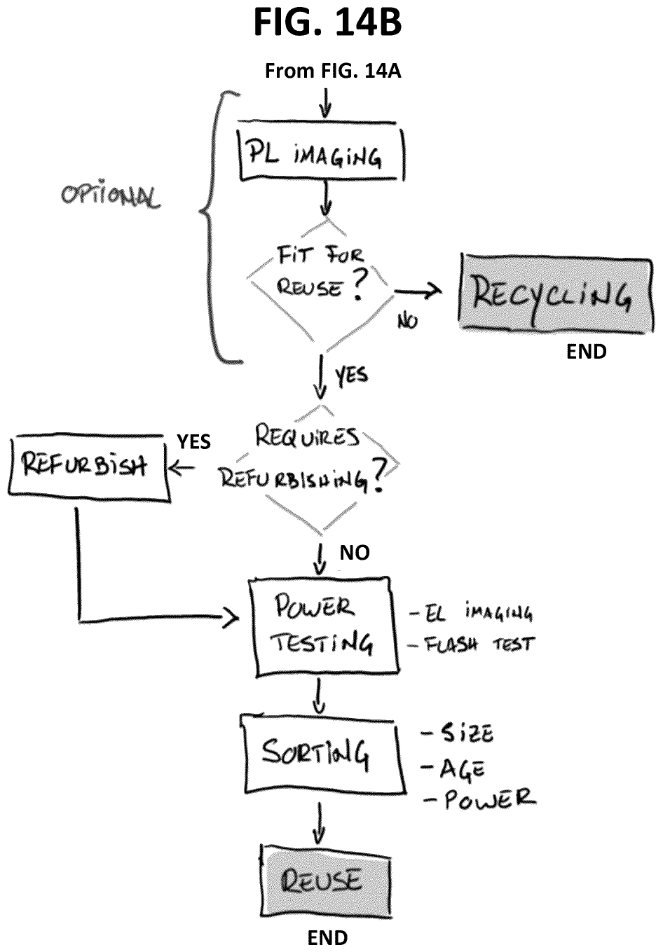

Returning now to the flow diagram of FIG. 12, when information is unavailable about the power output of the modules, a more comprehensive testing protocol may be utilized. Such a more detailed testing protocol is shown in FIGS. 14A-B.

The comprehensive testing protocol may or may not start with photoluminescence (PL) imaging. PL exposes the module to light in order to generate an electric response (e.g., current). PL imaging results may determine whether a module is unfit for reuse, and thus should be sent to recycling.

PL results may also decide if the module requires refurbishment. A module may call for refurbishment according to the PL imaging results, and/or if visual inspection reveals a junction box is damaged.

If a module requires refurbishment, it can first be refurbished accordingly before moving to the next step. For example, connectors that are worn or cracked can be replaced.

It is noted that a module may include diodes and other electronics. These may be considered during refurbishment, where the junction box is inspected for a fault that can be resolved to reuse the module.

If a module does not require refurbishment, it can be tested. A variety of apparatuses can be used for testing, including but not limited to one or more of:
a flash tester,
visual inspection,
PL,
electroluminescent (EL) imaging,
infra-red imaging,
wet leakage for safety.

EL and PL are different approaches. While PL uses light to elicit an electric response, for EL current is used to elicit a light response.

The output (result) of EL and PL are similar—an image of the module revealing special properties (akin to an Xray to look at human bones). EL and PL can reveal issues including but not limited to:
micro cracks,
dead cells, and/or
electron movement (minority carrier lifetime).

It is noted that simple visual inspection can show cracks and failures in the glass, backsheet, or cell. Visual inspection can spot broken frames, and/or show moisture concentration (resulting, e.g., from leaks.)

Infrared imaging shows a heat map of the modules, and can assist in identifying “dead cells”. A cell that is “dead” (faulty, non-functional) end up heating up more than its counterparts, producing a different color in the heat map.

According to particular embodiments, testing can be performed with the frame in place. This is because where testing reveals a module that is eligible for refurbishment and reuse, prior removal of the frame can be undesirable for these purposes.

Testing can determine the working condition of the module or string thereof, including characteristics including but not limited to:
power output,
current output,
voltage output,
cracks in PV cells,
string deterioration,
delamination.

As shown in FIGS. 14A-B, modules undergoing testing can then be sorted according to one or more factors including but not limited to:
power output,
age
size
number of cells
weight.

It is emphasized that the flow of events depicted in the diagrams of FIGS. 12-14B are merely examples, and should not be construed as exclusive or limiting. Thus, the order of events may differ depending upon the particular embodiment. Moreover certain events may be omitted, or additional events may take place, again depending upon the specific embodiment.

While separate, dedicated tools may be used for each of the activities described herein, this is not required. Certain embodiments may combine multiple functionality in a single tool. For example, some embodiments could combine PL and polarized light inspection in a same tool. Also, a deframing tool could further serve to remove a junction box from a module.

It is also emphasized that the above approaches may be utilized alone, or in various combinations in order to effect the recycling and/or refurbishment of solar modules.

Certain embodiments may employ Artificial Intelligence (AI) techniques to collect and analyze data associated with material input to a solar module recycling system including e.g., AI model(s), and/or the recycling and recapture of the component materials. An outcome of this analysis can offer estimates of resultant effect(s) upon speed and efficiency, by which materials travel through the recycling system.

Application of AI to solar module recycling, can afford a number of possible benefits. One benefit is the ability to rapidly optimize system parameters, providing high solar module throughput in the recycling system over time.

AI systems reference large datasets to make informed decisions and optimize processes. In the solar panel recycling industry, data acquisition can occur throughout the recycling process.

To achieve such data collection, recycling system hardware for various functional areas may be integrated to a central engine for processing and/or storage. Such functional areas may include, but are not limited to, the following bulleted items (with sub-bullets describing types of data acquisition and sensor/instrumentation that may be used to construct a database):
Junction box removal
Measurement
Weight of module
Weight of removed jbox
Time per removal
Cameras integrated into AI systems to identify and classify junction box (jbox) metadata
Frame removal
Measurements of panel length and width
Measurement of force required to remove each frame side
Weight of each piece of frame
Cameras integrated into AI systems to identify and classify metadata, e.g., how many screws the frame has, what type of adhesive is in place, others(s)
Glass removal
Measurement of ambient temperature of de-jboxed/deframed panel
Particle size reduction
Measurement of temperature within crushing/grinding equipment
Density separation
Conductivity separation
Chemical separation

Embodiments could measure and feed into AI systems (e.g., comprised of artificial neural networks), and carry out maintenance data per-functional area. For example, such information could include expected downtime of particular functional areas that are attributable to periodic upkeep.

It is noted that the efficiency of module travel through a recycling system is measured by the rate of recovery of its component materials. An AI system receiving time-based and maintenance-based data as described above, could then (automatically) control parameters of a module recycling system to achieve improved performance.

Thus, according to one possible example, the system parameter of “Crusher Rotations Per Minute (RPM)”, could be controlled to limit an amount of elemental Lead (Pb) that may contaminate material outputs of that (crushing) functional area.

Where multiple recycling systems are employed (e.g., over a wide geographic area), data acquisition can be fed from each individual system to a set of centralized servers connected via a network. These multiple systems could include but are not limited to:
crystalline silicon (c-Si) photovoltaic (PV) material solar module recycling systems;
cadmium telluride (CdTe) PV material solar module recycling systems; and/or
other solar module technology recycling systems—such as Copper Indium Gallium Diselenide—(CIGS) modules, perovskite modules.

In certain embodiments, one or more functional area(s) may be equipped with Programmable Logic Controllers (PLCs) furnished with a high number of input/output channels. Sensors and instrumentation can collect data and control the recycling process based on the processed data.

Robotic mechanical elements throughout the recycling system may determine the flow of material based on the data acquired. Such robotic elements can also be controlled based upon the results of AI according to embodiments.

Over time, embodiments could learn which materials are easier to recycle with lower calibration effort to the overall system. Embodiments could also learn which materials offer high rates of recovery for injection back into the circular economy.

Moreover, information collected and processed for solar module recycling could also inform module manufacturing efforts. Generative AI according to embodiments could be employed to create reports and manufacturing guidelines to assist solar panel manufacturing entities responsible for building solar modules designed for recycling.

As non-exclusive examples, sample guidelines could include, but are not limited to, recommendations for:
Sealant and potting material for junction boxes
Frame design; materials of composition, structural durability
Adhesive materials/compounds to affix glass to the top of the array of solar cells
Solar cell chemical composition

In this manner, the application of AI to solar module recycling could reduce production cost per panel. Such knowledge could in turn offer a competitive advantage in the field of solar module manufacturing.

Particular embodiments may employ AI techniques to classify used photovoltaic modules for one or more of: •reuse, •refurbishment, •recycling (including partial recycling), and/or •discard. Particular embodiments apply image recognition to the results of interrogation of incoming used solar modules.

Such interrogation may comprise one or more techniques, such as:
Electroluminescence (EL);
Photoluminescence (PL);
InfraRed (IR) imaging;
flash testing;
X-Ray Diffraction;
visual inspection;
inspection under applied polarized light;
photographic inspection of multiple modules (including geospatial), a discrete module, and/or a module portion;
hyperspectral imaging (capturing a broad spectrum of light beyond visible light);
electrical impedance tomography;
computed tomography;
ultrasound imaging;
acoustic imaging; and/or
nuclear magnetic resonance-based imaging techniques.

Particular embodiments may employ AI techniques to classify intermediary products of solar module recycling (e.g., for purposes of making a decision as to whether to supply these materials to off-takers, or to continue refining/purifying these materials. According to one possible example, AI may consider as inputs chemical composition measurements of refined recycling materials, e.g., to determine how much elemental Silver (Ag) is present and/or available for recapture.

Such interrogation may comprise one or more techniques, including but not limited to one or more of the following to determine chemical composition:
X-ray Fluorescence measurements;
Inductively coupled plasma-optical emission spectrometry (ICP-OES) measurements; and/or
Atomic Absorption Spectroscopy measurements.

The result of such AI image recognition, may be combined with other information, including but not limited to one or more of:
information from the label of the used PV module, including, e.g., one or more of:
   model,
   manufacturer,
   maximum power rating
   PV module type (ex: c-Si versus CdTe)
history information of the used PV module, including, e.g., one or more of:
   deployment site (residential, utility, rooftop, ground),
   deployment location (geographic location associated with rain, snow, winds),
   installation date(s),
   junction box (e.g., potted or not),
   frame materials,
   maintenance/cleaning history,
   prior testing (power per module, power per string of cells),
   report of known damage (e.g., “shading” or hail damage)
general information regarding the used PV module, including, e.g., one or more of:
   reported defects,
   reliability,
   market (and historical) resale value,
   PV material (e.g., including hazardous materials such as Cd/Te),
   hazardous waste disposal costs,
   electronics data—such as power, diodes, and/or inverters,
   junction box (e.g., potted or not),
   frame materials,
   warranty information
   photovoltaic efficiency
predicted information of the used PV module, including, e.g. one or more of:
   end of life in years/months (if reusable);
   expected power in the next 2 years;
   expected market resale value in the next 2 years;
   expected cost to recycle the panel.

Based upon the processing of one or more varieties of the types of information listed above, a rule set may be applied to determine an outcome for the incoming used solar module. Several different outcomes are possible.

The condition evaluation may reveal that the used solar module is suitable for reuse. That is, even including one or more defects, the used solar panel may have a value that dictates its reuse.

The condition evaluation may reveal that the used solar module is suitable for refurbishment. That is, actions such as one or more of the following refurbishment actions may result in a module that is suitable for reuse:
cable replacement;
junction box replacement;
frame replacement;
front sheet replacement;
back sheet replacement;
inverter replacement;
(bypass) diode replacement;
jbox potting/unpotting;

The condition evaluation may reveal that the used solar module is suitable for recycling (including partial recycling). Materials that may be recovered by such recycling can include but are not limited to:
cable metals (e.g., copper);
frame metals;
front sheet materials (e.g., optical glass);
solar cell PV materials (e.g., doped crystalline silicon);
solar cell conductor materials (e.g., copper ribbons, silver fingers);
module conductors (e.g., ribbons)
backsheet materials.

The condition evaluation may reveal that the used solar module is suitable for discarding (including partial discarding). Materials that may be discarded can include but are not limited to:
polymer of the used module;
other components of the used module that are not cost-effective to recycle.

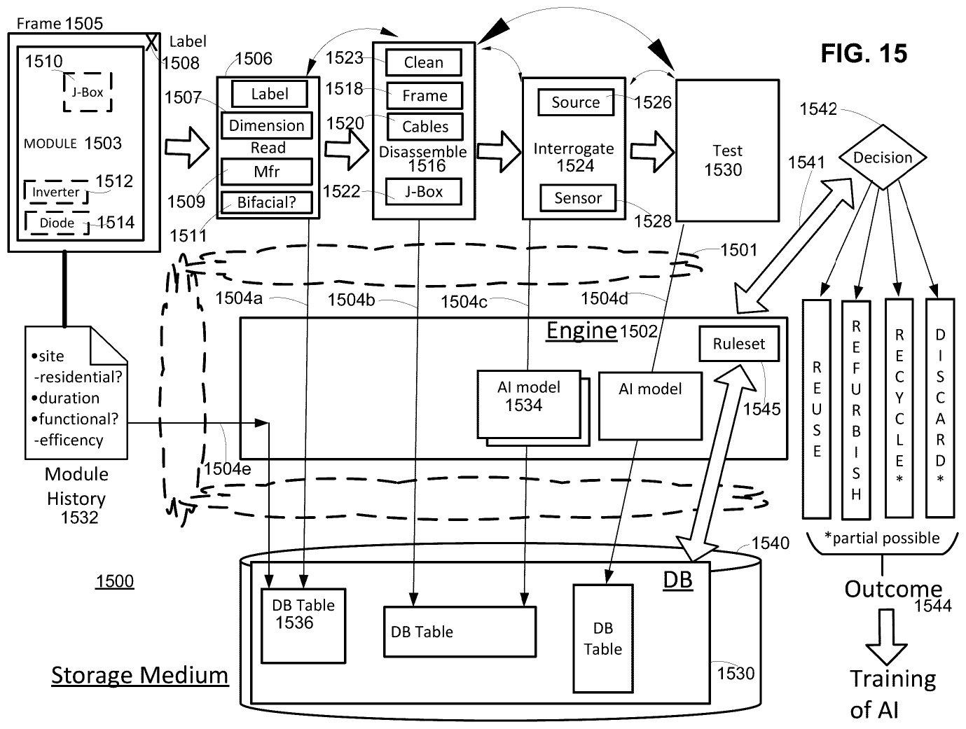

FIG. 15 shows a simplified block diagram of handling of a used solar module according to an embodiment. In particular, engine 1502 is configured to receive one or more inputs from an incoming solar module 1503. Those inputs may be received via a computer network such as the cloud 1501.

A first possible input 1504a comprises information read 1506 from the solar module. Such information can be read from module label(s) 1508, which may be present on a frame 1505 of the module. The information can indicate the dimension(s) 1507 of the module, its manufacturer (Mfr) 1509 and also bifaciality 1511 of the module.

Information read from the incoming module can relate to the number of, location of, and type of (potted, non-potted) of junction box(es) 1510 of the module. Other information can relate to electronics present in the module, such as inverter(s) 1512 and/or diode(s) 1514.

A second possible input 1504b that is received as an input by the engine, relates to disassembly 1516 of the solar module. Such disassembly can involve deframing 1518, cable removal 1520, and/or junction box removal 1522. Disassembly can also include cleaning 1523 of the module following its deployment.

A third possible input 1504c received as input by the engine, relates to interrogation 1524 of the solar module. Such interrogation may arise from a source 1526, such as electromagnetic radiation. The result of the interrogation is received by a sensor 1528, which communicates a corresponding signal to the engine.

A fourth possible input 1504d that is received as input by the engine, results from testing 1530 of the module. Such testing can determine the working condition of the module or string thereof, including characteristics including but not limited to:
power output,
current output,
voltage output,
cracks in PV cells,
string deterioration,
delamination.

Depending upon the information that is available and/or other considerations, a comprehensive testing protocol or condensed testing protocol may be employed. For example, where recent efficiency data is already available, a condensed testing protocol may be used instead in order to conserve effort.

Yet a fifth possible input 1504e to the engine, comprises information received from other than the solar module directly. According to one example, the engine could receive from the former owner of the module, a file reflecting a module history 1532. Such a history could include data indicating the former installation site, the date of installation (and hence the duration of deployment), functional information such as efficiency, and maintenance records. These could all factor into the ultimate determination of module condition being made by the engine.

Having received the one or more inputs, the engine performs processing based upon AI principles. In particular, the engine may reference one or more AI models 1534 that provide an output based upon the inputs.

Such AI model(s) may have been trained according to previous outcomes. That is, a training corpus for the AI model may reflect known results of applying the inputs, and is used to train the model to accurately predict future outcomes based upon new inputs.

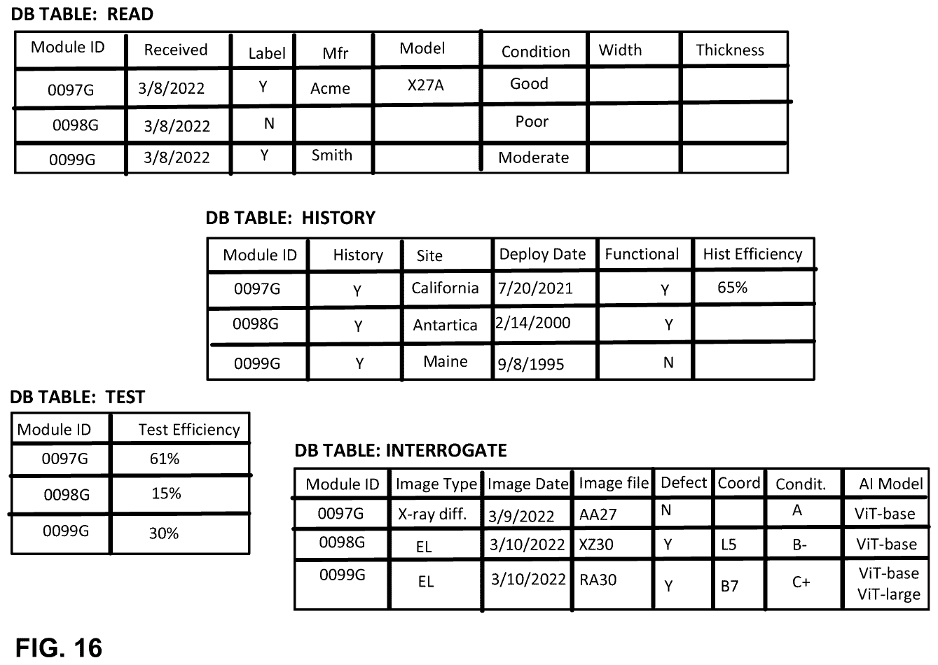

The engine stores raw inputs, as well as outcomes of application of AI model(s) thereto, in various tables 1536 of a database 1538 that is present in a non-transitory computer readable storage medium 1540. Exemplary, non-exclusive database tables are shown in FIG. 16, and many others are possible.

Then, by referencing 1541 the engine, a decision 1542 as to the future disposition of a particular solar module may be made. The decision may be based upon a ruleset 1545 that considers the output of one or more AI models. A variety of outcomes 1544 are then ultimately possible.

One outcome may be to reuse the solar module. That is, inputs may indicate that market resale or other conditions justify simply reusing the module in its current condition.

Another outcome may be refurbish the solar module. That is, certain components such as the junction box, electronics, frame, connection cable(s), or other may be replaced, and the resulting refurbished solar module then made available.

Still another outcome may be to recycle at least part of the solar module. For example, the solar module will typically include valuable materials.

Such module materials may be valuable due to their scarcity. Examples include precious metals such as silver, copper, and other metals.

Such module materials may be valuable to their high degree of purity. Examples of expensive, extremely high purity materials include optical glass, and photovoltaic materials such as precisely doped crystalline silicon and CdTe.

Performing recycling according to embodiments, can capture the economic value of these materials. Thus, precious metals and/or highly purified materials can be collected and offered for reuse in the marketplace (e.g., in fabricating new solar modules).

Lastly, another possible outcome may be to discard the module (in whole or in part). This outcome too can offer possible financial benefit. For example, a used module may include materials deemed environmentally sensitive (e.g., CdTe), and hence not suitable for disposal in an ordinary landfill. AI principles utilized according to embodiments that recognize such conditions, allow efficient diversion of a used module to the appropriate destination for disposal.

Outcome(s) of processing solar modules for recycling, could in turn be fed back to add to the data corpus used in training AI model(s). This can increase accuracy of an AI model. And, as mentioned above, collected data regarding solar module recycling could eventually be leveraged in order to provide valuable insights into the manufacturing of solar modules.

It is emphasized that FIGS. 15-16 show only one particular embodiment, and that others are possible. For example, the order of events is not limited to those shown, and other orders of events could occur (as indicated, e.g., by curved double arrows). Thus, interrogation could be employed before and/or after disassembly and/or testing; testing could be employed before and/or after interrogation, etc.

Moreover, the database tables of FIG. 16 are only examples, and many other types of tables could be used. For example, another possible sample database table is given below.

DB TABLE: AI PREDICTION

| Module | Power (W) | | Market resale value ($) | | End-of-life (Years) |
|---|---|---|---|---|---|
| ID | Current | 2 years | Current | 2 years | — |
| 0097G | 225 | 200 | 5000 | 3000 | 5 |
| 0098G | 200 | 187 | 1000 | 0 | 2 |
| 0099G | 120 | 45 | 0 | 0 | 0 |

As described above, and also disclosed in connection with the specific example below, the application of AI techniques may provide for efficient and accurate assessment of used module condition.

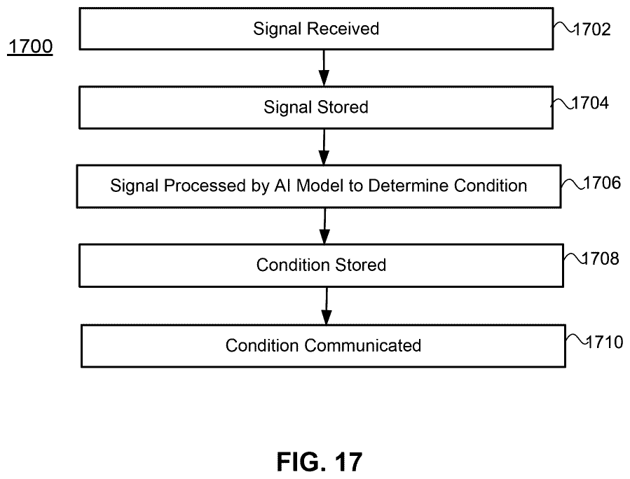

FIG. 17 is a simplified flow diagram 1700 showing application of AI to evaluating condition of used solar modules.

At 1702, a signal from interrogation of a used solar module, is received. At 1704, the signal is stored.

At 1706, the signal is processed according to an AI system to determine a condition of the used solar module. At 1708, the condition is stored.

At 1710, the condition is communicated to a user.

The condition itself may be a recommendation of an ultimate outcome for handling of the module. This outcome may recommend reuse, refurbishment, (partial) recycling, and/or (partial) discard of a used module.

Optionally, a ruleset may be applied to the condition to provide the ultimate outcome. This could allow considerations other than interrogation result (e.g., history, label, other) to factor into the outcome.

### Example

A total of one-hundred and five (105) used solar modules from four (4) different manufacturers, were exposed to EL imaging.

TABLE I
Original data

| Module Mfg | # of Recyclable Mod | # of Non-Recyclable Mod | Total |
|---|---|---|---|
| First | 8 | 6 | 14 |
| Second | 3 | 9 | 12 |
| Third | 0 | 13 | 13 |
| Fourth | 13 | 52 | 66 |

This incoming data exhibited class imbalance(s). Class imbalance refers to the disparity in the number of available samples on a dataset, where classes (i.e. categories belonging to one or more groups) are more abundant than others, potentially jeopardizing the AI prediction capabilities. For example, none of the used solar modules available from the third manufacturer were deemed recyclable.

To address the class imbalance—the overall uneven distribution of images among manufacturers and among categories (#of Recyclables vs. #of Non-Recyclables modules)—in this original data corpus, data augmentation techniques were employed.

Such data augmentation techniques seek to minimize potential bias(es) within the dataset. Here, the TrivialAugment method was used for data augmentation. Under that technique, linear transformations (e.g. scaling, shearing, rotation and translation operations) and nonlinear transformations (e.g. random adjustments in color, contrast, sharpness and image equalization) are applied to the original dataset, affording synthesis of new EL image samples comprising the augmented dataset.

Table II presents a summary of the augmented EL module images.

TABLE II
Augmented Data

| Module Mfg | # of Recyclable Mod | # of Non-Recyclable Mod | Total |
|---|---|---|---|
| First | 42 | 48 | 90 |
| Second | 45 | 45 | 90 |
| Third | 0 | 13 | 13 |
| Fourth | 42 | 52 | 94 |

It is noted that alternative data augmentation techniques (other than the TrivialAugment method) could be used in conjunction (or exclusively) for tackling the imbalance of the original dataset. Data augmentation techniques that may be used, include but are not limited to:
Application of linear transformations:
scale;
rotation;
translation;
shearing;
Application of nonlinear transformations:
Nonlinear color adjustment (e.g. changes in brightness, contrast, saturation, hue; application of solarization and equalization techniques);
Geometric distortions of images (e.g. image warping and image resizing);
Application of different types of noise such as additive (e.g. Gaussian noise) and multiplicative (e.g. speckle noise);
Use of deep learning based models:
Generative adversarial networks;
Diffusion models.

It is further noted that preprocessing techniques (other than image augmentation techniques) could be applied, including but not limited to one or more of:
Image cropping (e.g. removing the borders of the EL panels);
Resizing and rescaling (e.g. adjusting the width and height of the image);
Image normalization (e.g. z-score and min-max normalization);
Color space conversion (e.g. from RGB to LAB/CMYK);
Noise reduction (e.g. median filtering, principal component noise reduction, Gaussian filtering);

This example relies upon the Vision Transformer (ViT) deep learning model to classify incoming EL images. In particular, the ViT deep learning model was initially trained in a supervised fashion using the ImageNet-21k database.

Then, this example fine-tuned the Vision Transformer (ViT) deep learning model to perform a simple classification of EL images of the augmented data set. The classification was as belonging to one of the following two (2) possible classes reflecting a module condition:
“recycle? Yes”; or
“recycle? No”.

It is emphasized that this classification of module condition is simplified, and others are possible. For example, the module condition could be reflected in the form of a gradation, with several intermediate stages from best to worst condition.

This classification relies upon the following:
two (2) sets of pre-initial weights (the learned parameters) of the following deep neural networks:
the “vit-base-patch16-224-in21k” available under the Apache-2.0 license, as a base model; and
the “vit-large-patch16-224-in21k” available under the Apache-2.0 license, as a large model.

Both the base and large models were pre-trained on 14 million images on an image classification task. The difference between the base and large models relies on the number of parameters in their architecture. The base model has 85 million parameters. The large model has 305 million parameters.

Using the strategy of fine-tuning these models from their initial pre-trained weights, we leverage their learned inner image representations and improve the accuracy of results for classifying EL images of used solar modules, in terms of their reusability.

The evaluation process used a 10-fold cross validation strategy. In each fold, 90% of the data is used for training; 10% of the data is used for validation.

To reduce random initialization impact upon model performance, the models were trained using five (5) different random initialization seeds. The reported final performance is the mean and standard deviation of metrics obtained across these different seeds.

The models were trained (e.g. fine-tuned) using AdamW advanced optimizer and the cross-entropy loss function. In general, the action of fine-tuning a pre-trained model with AdamW and cross-entropy comprises refining the parameters of a model already trained on a task of classifying images of general categories (e.g., •car; •person; •house) to specific categories (e.g., •“recycle? Yes”; •“recycle? No”).

The training process was performed on a single NVIDIA GeForce RTX 3060 Graphic Processing Unit (GPU).

A hyperparameter search was performed to identify:
the optimal learning rate,
the batch size, and
the number of epochs.

Hyperparameters achieving highest classification accuracy on a given fold of the validation set, are described in Table III.

TABLE III
Tuned hyperparameters

| ViT Model | #Parameters | Learning Rate | Batch Size | #epochs |
|---|---|---|---|---|
| base-pvdetector | 85M | 0.00002 | 16 | 20 |
| large-pvdetector | 305M | 0.00002 | 16 | 50 |

To assess the performance of our image classification model, we used the evaluation metrics listed in Table IV.

TABLE IV
Evaluation metrics

| Metric | Implementation |
|---|---|
| Accuracy | The percentage of correctly classified images. |
| Specificity | Greater values indicate that the predictive model is good at |
| | correctly identifying instances from the class “recycle? No”. |
| Sensitivity | Greater values indicate that the model is good at correctly |
| | identifying instances from the class “recycle? Yes”. |
| Precision | Quantifies the accuracy of positive (“recycle? Yes”) |
| | predictions made by a model. |
| F1-score | A high F1-score indicates a good balance between precision |
| | and sensitivity. |

We implemented the deep learning image classification solution using Python. We implemented the interactive real-time web application (both backend and frontend) using Python.

The results of our experimental analysis are presented in Table V and Table VI. In Table V, we report the performance metrics of our model, including Accuracy, Specificity, Precision, Sensitivity, and F1-score.

TABLE V
Mean and standard deviation metrics [%] across all seeds.

| ViT Model | Accuracy | Specificity | Precision | Sensitivity | F1-score |
|---|---|---|---|---|---|
| base- | 90.2 ± 1.4 | 92.2 ± 1.9 | 91.1 ± 3.1 | 87.0 ± 1.8 | 88.7 ± 2.6 |
| pvdetector | | | | | |
| large- | 94.2 ± 1.5 | 96.0 ± 0.7 | 95.2 ± 1.5 | 92.2 ± 2.4 | 93.3 ± 2.3 |
| pvdetector | | | | | |

Table V presents the mean and standard deviation of the metrics obtained using the base and large fine-tuned models. These metrics provide valuable insights into the overall effectiveness of our proposed approach. More specifically, it can be observed that the overall ability of the model to correctly classify both the categories “recycle? Yes” and “recycle? No” (i.e. its accuracy) are 90.2% for the base-pvdetector and 94.2% for large-pvdetector.

Table VI shows execution time for inference per image.

TABLE VI
Mean and standard deviation of execution
time (in sec) of inference/image

Hardware

| ViT Model | Intel ® Core ™ i7-10510U | Webapp |
|---|---|---|
| base-pvdetector | 0.27 ± 0.02 | ~2.09 ± 0.52 |
| large-pvdetector | 0.30 ± 0.03 | Not evaluated. |

This aspect of execution time, can be relevant to implementation of real-time applications. Our model demonstrates competitive inference speed, making it a viable solution for practical deployments.

Clause 1A. A method comprising:
receiving from a sensor, a signal from interrogation of a used solar module;
storing the signal in a non-transitory computer readable storage medium;
processing the signal according to an artificial intelligence model to determine a condition of the used solar module;
storing the condition in the non-transitory computer readable storage medium; and
communicating the condition to a user.

Clause 2A. A method as in Clause 1A further comprising generating the artificial intelligence model from a training corpus.

Clause 3A. A method as in Clause 2A wherein the training corpus results from data augmentation.

Clause 4A. A method as in any of Clauses 1A, 2A, or 3A wherein the signal comprises an electroluminescence (EL) signal.

Clause 5A. A method as in any of Clauses 1A, 2A, 3A, or 4A wherein the artificial intelligence model comprises a deep learning model.

Clause 6A. A method as in any of Clauses 1A, 2A, 3A, 4A, or 5A wherein the artificial intelligence model is self-attention-based.

Clause 7A. A method as in any of Clauses 1A, 2A, 3A, 4A, 5A, or 6A wherein the artificial intelligence model is transformer-based.

Clause 8A. A method as in any of Clauses 1A, 2A, 3A, 4A, 5A, 6A, or 7A wherein the condition indicates that at least a portion of the used solar module is suited for refurbishment.

Clause 9A. A method as in any of Clauses 1A, 2A, 3A, 4A, 5A, 6A, 7A, or 8A wherein the condition indicates that at least a portion of the used solar module is suited for recycling.

Clause 10A. A method as in any of Clauses 1A, 2A, 3A, 4A, 5A, 6A, 7A, 8A, or 9A wherein the artificial intelligence model comprises a neural network.

Clause 11A. A method as in any of Clauses 1A, 2A, 3A, 4A, 5A, 6A, 7A, 8A, 9A, or 10A wherein the artificial intelligence model comprises a support vector machine.

Clause 12A. A method as in any of Clauses 1A, 2A, 3A, 4A, 5A, 6A, 7A, 8A, 9A, 10A, or 11A wherein the artificial intelligence model is trained using ImageNet.

Clause 13A. A method as in any of Clauses 1A, 2A, 3A, 4A, 5A, 6A, 7A, 8A, 9A, 10A, 11A, or 12A wherein the signal is received with a junction box of the used solar module being present.

Clause 14A. A method as in any of Clauses 1A, 2A, 3A, 4A, 5A, 6A, 7A, 8A, 9A, 10A, 11A, or 12A wherein the signal is received with a junction box of the used solar module having been removed.

Clause 15A. A method as in any of Clauses 1A, 2A, 3A, 4A, 5A, 6A, 7A, 8A, 9A, 10A, 11A, 12A, 13A, or 14A wherein the signal is received with a frame of the used solar module being present.

Clause 16A. A method as in any of Clauses 1A, 2A, 3A, 4A, 5A, 6A, 7A, 8A, 9A, 10A, 11A, 12A, 13A, 14A, or 15A wherein the signal is received with a frame of the used solar module having been removed.

Clause 17A. A method as in any of Clauses 1A, 2A, 3A, 4A, 5A, 6A, 7A, 8A, 9A, 10A, 11A, 12A, 13A, 14A, 15A, or 16A wherein the signal is received with a transparent front sheet of the used solar module being present.

Clause 18A. A method as in any of Clauses 1A, 2A, 3A, 4A, 5A, 6A, 7A, 8A, 9A, 10A, 11A, 12A, 13A, 14A, 15A, or 16A wherein the signal is received with a transparent front sheet of the used solar module having been removed.

What is claimed is:

1. A method comprising:
receiving from a sensor, a signal from interrogation of a used solar module;
storing the signal in a non-transitory computer readable storage medium;
processing the signal according to an artificial intelligence model to determine a condition of the used solar module;
storing the condition in the non-transitory computer readable storage medium; and
communicating the condition to a user.

2. The method of claim 1 wherein the signal comprises a luminescence signal.

3. The method of claim 2 wherein the signal comprises a photoluminescence signal.

4. The method of claim 2 wherein the signal comprises an electroluminescence signal.

5. The method of claim 1 wherein the signal results from the application of polarized light.

6. The method of claim 1 wherein the signal indicates broken glass of the used solar module.

7. The method of claim 1 wherein the condition is stored in a database of the non-transitory computer readable storage medium.

8. The method of claim 7 wherein a model of the used solar module is stored in the database.

9. The method of claim 7 wherein a glass thickness of the used solar module is stored in the database.

10. The method of claim 1 further comprising sorting the used solar module.

11. The method of claim 10 wherein the sorting occurs after the storing of the condition.

12. The method of claim 10 further comprising:
referencing a factor stored in a database to output information relating to the used solar module; and
the sorting is based upon the information.

13. The method of claim 12 wherein the information is obtained as part of a history file.

14. The method of claim 12 wherein the information is obtained from a manufacturer of the used solar panel, an owner of the used solar panel, a research institute, or a public source.

15. The method of claim 12 wherein the factor is a thickness of glass of the used solar panel.

16. The method of claim 12 wherein the factor is a model of the used solar panel.

17. The method of claim 1 wherein the signal indicates a chemical composition.

18. The method of claim 17 wherein the signal is a result of one or more of:
X-ray Fluorescence;
Inductively coupled plasma-optical emission spectrometry (ICP-OES); and
Atomic Absorption Spectroscopy.

19. The method of claim 1 wherein the signal results from a flash.

20. The method of claim 1 wherein the artificial intelligence model comprises image recognition.
